(19) United States
(12) Patent Application Publication
(10) Pub. No.: US 2020/0114432 A1
(43) Pub. Date: Apr. 16, 2020

(54) METHOD FOR ASSEMBLING A TOOL SYSTEM MODULE, AND TOOL SYSTEM MODULE PRODUCED ACCORDINGLY

(71) Applicant: GUEHRING KG, Albstadt (DE)

(72) Inventor: Jochen GRUBER, lnzigkofen (DE)

(73) Assignee: GUEHRING KG, Albstadt (DE)

(21) Appl. No.: 16/662,261

(22) Filed: Oct. 24, 2019

Related U.S. Application Data
(63) Continuation of application No. PCT/DE2018/100393, filed on Apr. 24, 2018.

(30) Foreign Application Priority Data
Apr. 24, 2017 (DE) 10 2017 108 719.2

(51) Int. Cl. B23B 31/02; B23P 15/28; B23K 26/34; B33Y 80/00; B33Y 40/20; B22F 3/00; B22F 3/24; B22F 5/10

(52) U.S. Cl. CPC B23B 31/02; B23P 15/28; B23K 26/34; B33Y 80/00; B23K 2101/20; B22F 3/008; B22F 3/24; B22F 5/106; B33Y 40/20

(57) ABSTRACT

The invention relates to a method for assembling a tool system module, having a main body (G3C), which comprises a standard shank, such as a hollow-shank-taper (HSK) shank, and having a functional section (F5Y), such as a tool holder. In order to produce such tool system modules particularly economically, the functional section (F5Y) is paired with a main body (G3C) that is produced on separate production line, which is independent of the design or the production line of the functional section.

The invention pertains to a method for assembling a tool system module, preferably a tool holder, which comprises a main body with a standard shank such as a hollow-shank-taper (HSK) shank and a functional section such as a tool clamping receptacle, as well as to a tool system module assembled in accordance with this method.

It is generally known, e.g. from documents DE 196 00 636 A1 or DE 41 17 900 A1, to construct tools such as shell end mills, which due to their volume can no longer be clamped in clamping chucks, in a modular manner. In this case, different receptacle parts in the form of a steep taper and flange with gripper groove can be separably coupled with different cylindrical cutting edge parts.

Components that are individually adapted to the customer requirements or to the specific machining problem are also increasingly used in tool technology or tool clamping technology, respectively. Consequently, tool system modules such as complete clamping chucks, which are ordered in different variations such as shrink-fit chucks, hydraulic expansion chucks, precision power chucks, straight shank chucks or draw-in collet chucks, clamping chuck and tool extensions, reducing bushings, etc., have to be quickly and economically produced in various sizes and geometries and in adaptation to the respective machining center.

Since more and more suitable metal powders are nowadays produced (see, for example, the articles “Die Vielfalt aus dem Pulver,” published in WB Werkstatt und Betrieb, Vol. 9/2016, pp. 118-121, and “Digitale Perspektiven,” published in WB Werkstatt und Betrieb, Vol. 1-2/2017, pp. 57-60), additive production processes are also used in the manufacture of tool clamping systems. Such additive processes are known under the designations stereo lithography (SL), 3D printing, fused deposition modeling (FDM), selective sintering, selective laser sintering (SLS), selective laser melting (SLM), laser metal deposition (LMD) and electron beam melting. Laser radiation is frequently used in this case for the production of the metal-based layers. Examples of such production methods are described, e.g., in publications DE 10 2013 103 168 B3, WO 2015/166068 A1, EP 1 864 748 B1, DE 10 2015 177 590 B3, EP 864 748 A1, WO 2013/098192 A1 and WO 2016/045681 A1. These methods resort to the speed and the flexibility of additive production processes.

The invention is based on the objective of making available a novel method for manufacturing a tool system module, by means of which tool system modules comprising a main body with a standard shank such as a hollow-shank-taper (HSK) shank and a functional section such as a tool holder can be manufactured even more economically, faster and with the utmost flexibility.

According to the invention, this objective is attained in that the functional section is not paired with a main body until the latter has been manufactured, preferably at least sectionally by means of a generative or additive production process, particularly by using a laser melting process such as selective laser melting (SLM), on a separate production line, which includes storage and is independent of the design or the production line of the functional section

The novel method has the significant advantage that various geometries of the main body and the functional section are respectively manufactured independently of the production process of the other system module component, wherein this not only makes it possible to save material and to minimize the volume of metal to be removed by cutting, but also to assemble arbitrary combinations of the system module components as quickly as possible. Consequently, these system module components can be produced in an optimized manner with respect to their manufacturing technology and even be stored independently of one another such that the customer can be provided with tool system modules of arbitrary composition as quickly as possible. In this case, the time required for the additive production of the main body does not negatively affect the production time of the tool system module because additively produced main bodies already can be kept in storage in all variations and sizes and paired with a corresponding functional section in the combination required for the use of the tool as needed. A significant advantage of the additive production of the main body can also be seen in that it is largely unaffected by the absolute magnitude of the dimensions. Consequently, the parameters of the manufacturing process can remain unchanged regardless of whether a standard shank with an extremely large diameter, e.g. an HSK-A125 for a tool holder according to DIN 69893-1, or a standard shank for small drilling tools with nominal diameters in the mm range is manufactured. The production is thereby significantly simplified because structural properties already can be purposefully influenced at arbitrary locations of the workpiece during the additive production such that, for example, separate hardening and heat treatments after the manufacturing process can be eliminated.

The main body with the standard shank usually has a large volume and a high weight, as well as a shape that is typically associated with a large volume of metal to be removed by cutting because a gripper groove for the automated tool change is normally provided. Consequently, the additive production of the main body, which is decoupled from the manufacture of the functional section, also significantly simplifies the manufacture of the functional section because the material removal and the weight of the main body no longer have to be taken into consideration.

Advantageous enhancements form the objects of the dependent claims.

It may furthermore be advantageous to respectively apply or build up the additively produced system module component (main body and/or a functional section) on a cylindrical blank with or without support structure by means of 3D printing. In this way, the blank can be used for making available the material for the connection to the functional section.

In order to improve the mechanical properties of the additively produced system module component, it is advantageous to subject the system module component to a heat treatment, particularly an artificial aging process, and/or to a thermochemical surface treatment.

It was determined that a sufficient strength (bending stress and torque transmission), as well as a sufficiently high concentricity, can be easily achieved when the additively produced system module component is integrally connected to the functional section or the main body, respectively.

The economic viability of the manufacturing process is not noticeably diminished if the additively produced system module component (main body or functional section) is subjected to a mechanical machining process to its final dimensions.

The essential component of the additively produced system module component or the main body preferably is steel or hard material.

The invention furthermore pertains to a tool system module according to claim 7, which is respectively manufactured or assembled in accordance with the above-described method. It is characterized in that the main body is at least sectionally produced by means of a generative or additive production process, particularly by using a laser melting process such as selective laser melting (SLM), and integrally connected to the functional section.

Advantageous enhancements form the objects of dependent claims 8 to 13.

The invention is described in greater detail below with reference to schematic drawings. In these drawings:

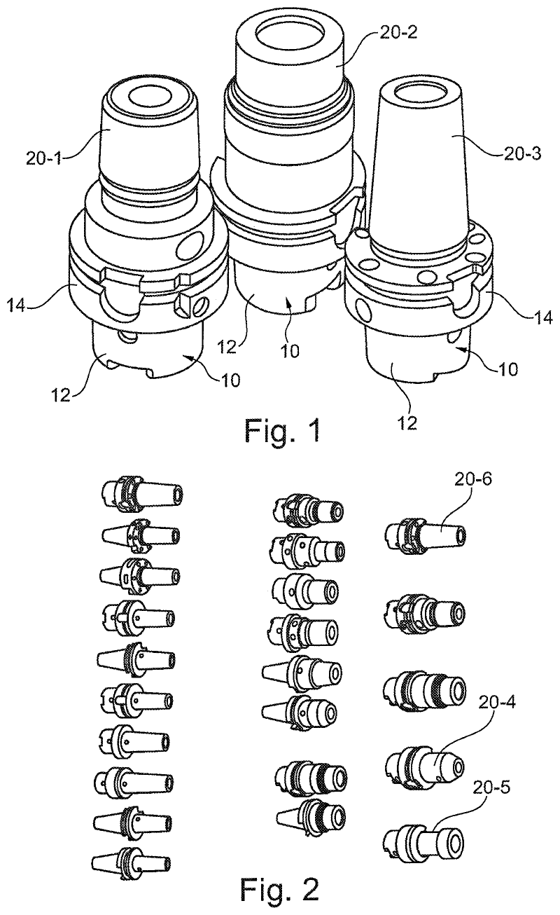

FIG. 1 shows a perspective view of three different tool system modules in the form of HSK clamping chucks;

FIG. 2 shows an exemplary set of a conventional assortment of tool system modules;

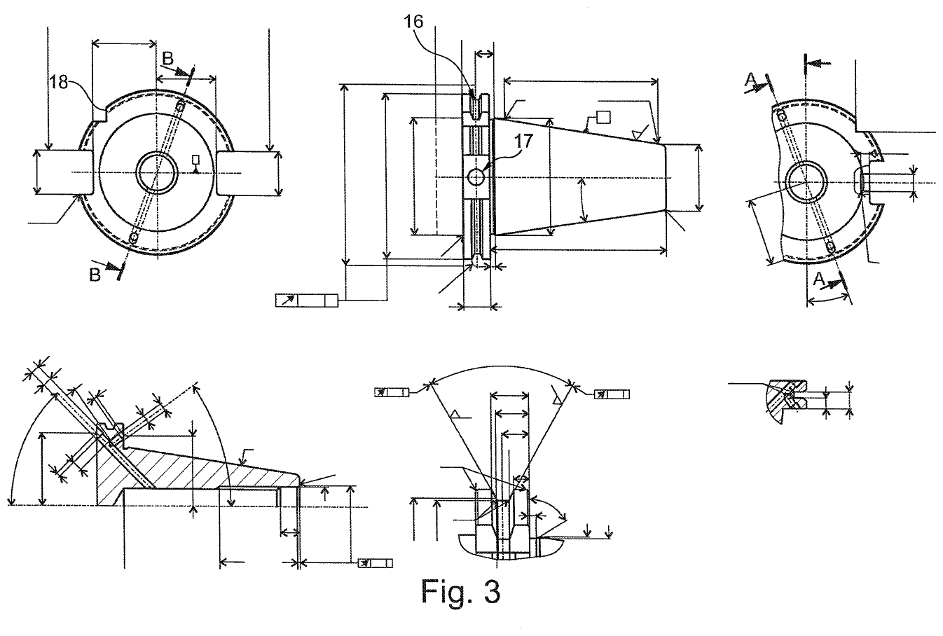

FIG. 3 shows an exemplary shop drawing of a main body equipped with a steep taper;

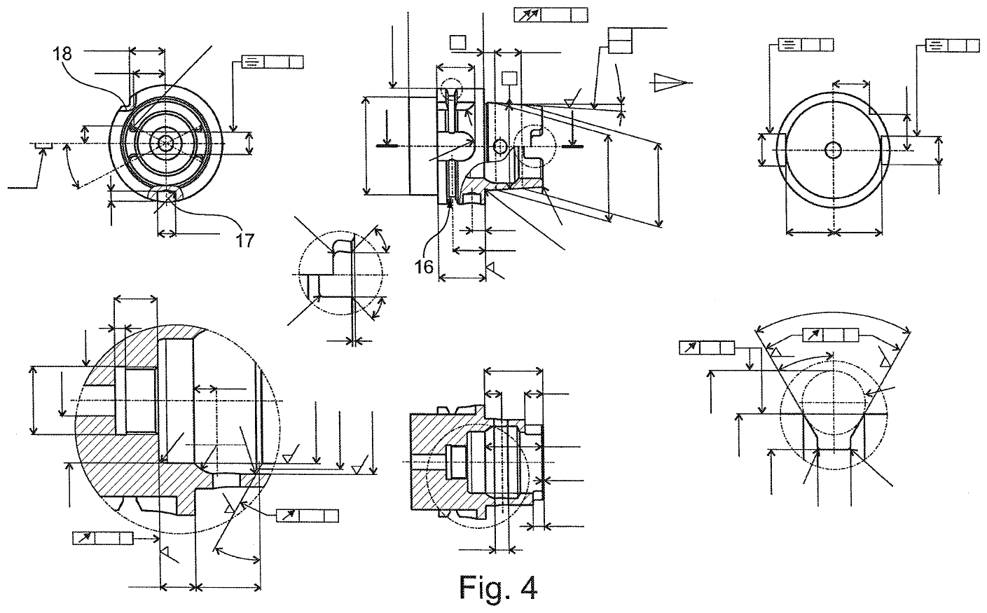

FIG. 4 shows an exemplary shop drawing of a main body equipped with a hollow-shank-taper (HSK);

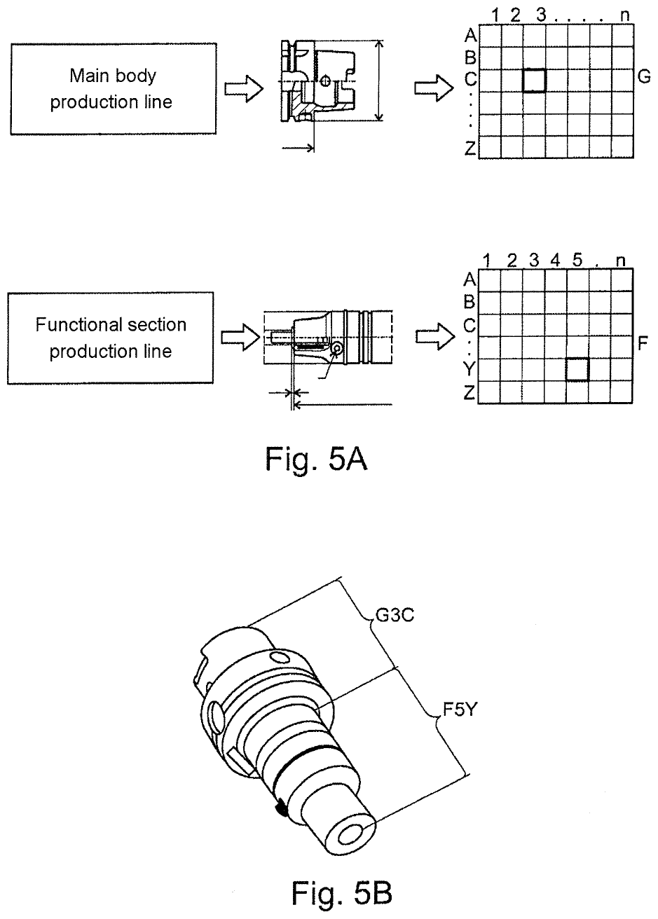

FIG. 5 A shows a schematic representation of the inventive production lines for the main body and for the functional section; and

FIG. 5 B shows a perspective view of a tool system module assembled in accordance with the invention.

FIG. 1 shows examples of three different tool system modules that are designed as tool receptacles in the form of HSK clamping chucks, which respectively comprise a main body 10 with a HSK standard shank 12 and a flange 14 and different functional sections 20-1, 20-2 and 20-3 carried by this main body. In the example shown, the functional section 20-1 is formed by a hydraulic expansion chuck, the functional section 20-2 is formed by a precision clamping chuck and the functional section 20-3 is formed by a shrink-fit chuck.

FIG. 2 illustrates the variety, in which such tool system modules are nowadays offered. Functional sections of the same design are produced with different types of taper shanks, namely also with standard steep taper shanks. Furthermore, these system modules are used and accordingly produced in different sizes on the part of the standard shank (HSK or steep taper), as well as on the part of the functional section for clamping tools of various diameters. In addition to shrink-fit chucks, FIG. 2 also shows examples of straight shank chucks 20-4, e.g. of the “Weldon”/“Whistle Notch” design, draw-in collet chucks 20-5 and shrink-fit chucks/shrink-fit extensions 20-6.

FIGS. 3 and 4 not only show that the functional section 20 has a relatively complex design, but also that the main body 10 can only be manufactured with significant production effort—even though the shank is subject to standardization. These figures show the extensive dimensioning with very narrow tolerance fields not only in the region of the standard shank 12, but also in the region of the adjacent flange 14 with gripper groove 16, coding bore 17 and indexing groove 18.

In order to manufacture the tool system modules, particularly tool holders, even more economically, faster and with even greater flexibility, the inventive method is characterized in that the functional section 20 is not paired with a main body 10 until the latter has been produced on a separate production line, which is independent of the design or the production line of the functional section. This is schematically illustrated in FIGS. 5A and 5B:

The production lines for the main body and for the functional section are realized separately and independently of one another. Consequently, the production of main bodies of various shapes and sizes—indicated by the matrix with the columns 1 to n and the lines A to Z—is decoupled from the manufacture of the functional sections 20—in likewise different types and sizes. The production may also take place in accordance with a multidimensional matrix. In addition, the individually produced system module components 10, 20 can be intermediately stored for on-demand retrieval.

The appropriate main bodies and functional sections are paired and rigidly joined to one another, e.g. bonded or welded, depending on the configuration of the system module requested by the customer. In the example illustrated in FIG. 5, the main body G3C is paired with the functional section F5Y, preferably integrally connected thereto.

In this way, various geometries of the main body and the functional section can be respectively manufactured independently of the production process of the other system module component. This not only saves material and minimizes the volume of metal to be removed by cutting, but also makes it possible to assemble arbitrary combinations of the system module components as quickly as possible. Consequently, these system module components can be produced in an optimized manner with respect to their manufacturing technology and even be stored independently of one another such that the customer can be provided with tool system modules of arbitrary composition as quickly as possible.

The inventive method makes it possible to manufacture all popular tool system modules, in which standard shanks are paired with different functional sections such as with a tool carrier shank, a tool shank or a tool clamping receptacle in the form of a hydraulic expansion chuck, a shrink-fit chuck, a power chuck, a straight shank chuck “Weldon”/“Whistle Notch” or a draw-in collet chuck.

According to an advantageous embodiment, at least the main body 10, the essential component of which may be steel or hard material, is at least sectionally manufactured by means of a generative or additive production process, particularly by using a laser melting process such as selective laser melting (SLM). In this context, any previously known additive production process or any additive production process currently in development may be used, for example the additive production processes known under the designations stereo lithography (SL), 3D printing, fused deposition modeling (FDM), selective sintering, selective laser sintering (SLS), selective laser melting (SLM), laser metal deposition (LMD) and electron beam melting.

The additively produced system module component (main body 10 and/or functional section 20) may also be applied on a cylindrical blank with or without support structure by means of 3D printing. The additively produced system module component (main body 10 and/or functional section 20) is then advantageously subjected to a heat treatment, particularly an artificial aging process, and/or to a thermochemical surface treatment.

The additively produced system module component, i.e. the main body 10 and/or the functional section 20, preferably is mechanically machined to its final dimensions.

The invention therefore creates a method for assembling a tool system module, which comprises a main body with a standard shank such as a hollow-shank-taper (HSK) shank and a functional section such as a tool holder. In order to manufacture such tool system modules in a particularly economical manner, the functional section is paired with a main body that is produced on a separate production line, which is independent of the design or the production line of the functional section.

1. A method for assembling a tool system module, which comprises a main body with a standard shank and a functional section, wherein the functional section is paired with a main body, which is at least sectionally produced by means of a generative or additive production process, on a separate production line that includes storage and is independent of the design or the production line of the functional section.

2. The method according to claim 1, wherein at least the main body is applied on a cylindrical blank with or without support structure by means of 3D printing.

3. The method according to claim 1, wherein at least the main body is subjected to a heat treatment, and/or to a thermochemical surface treatment.

4. The method according to claim 1, wherein the main body is integrally connected to the functional section.

5. The method according to claim 1, wherein at least the additively produced main body is subjected to a mechanical machining process to its final dimensions.

6. The method according to claim 1, wherein the essential component of the main body is steel or hard material.

7. A tool system module, which comprises a main body with a standard shank and a functional section, wherein the main body is at least sectionally produced by means of a generative or additive production process, and integrally connected to the functional section.

8. The tool system module according to claim 7, wherein the main body is applied on a cylindrical blank with or without support structure by means of 3D printing.

9. The tool system module according to claim 7, wherein the main body is subjected to a heat treatment, and/or to a thermochemical surface treatment.

10. The tool system module according to claim 7, wherein the main body is subjected to a mechanical machining process to its final dimensions.

11. The tool system module according to claim 7, wherein the essential component of the main body is steel or hard material.

12. The tool system module according to claim 7, wherein the main body has a flange with gripper groove, coding bore and indexing groove adjacent to the standard shank.

13. The tool system module according to claim 7, wherein the functional section forms a tool carrier shank, a tool shank or a tool clamping receptacle in the form of a hydraulic expansion chuck, a shrink-fit chuck, a power chuck, a straight shank chuck “Weldon”/“Whistle Notch” or a draw-in collet chuck.
